(19) United States
(12) Patent Application Publication
(10) Pub. No.: US 2002/0099939 A1
(43) Pub. Date: Jul. 25, 2002

(54) Internet key exchange

(75) Inventor: Tse-Huong Choo, Bristol (GB)

Correspondence Address: IP Administration, C/o Hewlett-Packard Company, 3404 East Harmony Road, Mail Stop 35, Ft. Collins, CO, 80528-9599, US

(73) Assignee: HEWLETT-PACKARD COMPANY

(21) Appl. No.: 09/858,483

(22) Filed: May 17, 2001

(30) Foreign Application Priority Data
May 24, 2000 (GB) 0012443.8

(51) Int. Cl. H04L 9/00

(52) U.S. Cl. 713/164; 713/171; 380/277

(57) ABSTRACT

The invention relates to Internet Key Exchange (IKE). IKE Main Mode generally takes a substantial and significant amount of time in which to implement and, where IKE is implemented in software, Main Mode cannot be given until full system start up has occurred, operation systems loaded etc. The method of the present invention proposes an accelerated form of IKE in which IKE Main Mode is carried out in hardware in parallel to system start up so that, once a system has started up and come fully on-line, the results of IKE Main Mode are already available and the IKE daemon may proceed directly with one or more Quick Modes.

The invention relates to Internet Key Exchange. In particular, the invention relates to a method for providing an accelerated Internet Key Exchange (IKE).

Virtual private networks (VPNs) are well known in the art. In a VPN, IP security protocol (IPSEC) routers are commonly used to take advantage of the internet to carry traffic between trusted parts with encryption being applied at the Internet Protocol (IP) level using IPSEC to provide communications security on the unsecure internet. Such an approach may use encrypting routers and not provide sites with access to untrusted internet sites. In other VPNs, firewalls can be usefully employed in which data is encrypted at the Internet Protocol (IP) level with IPSEC. Such firewalls encrypt all traffic between trusted sites and provide controlled access to untrusted hosts. Strong firewall access control is necessary in such a set-up to reduce the risk of successful attacks from third parties. The firewall approach lets people from within the trusted sites access public internet services and provides security against outsiders accessing the site.

IPSEC is a set of general protocols for protecting TCP/IP communications which work best when protecting traffic between hosts and not between users on a given host. The main requirements of IPSEC are to protect traffic between trusted hosts from forgery or eavesdropping, to protect the whole range of internet software currently in use, to enable the use of an untrusted network to carry traffic between trusted hosts, and to provide automatic protection between hosts needing such protection.

Hosts using IPSEC need to establish a security association. This establishes what types of protection to apply, how to do the encryption or authentication and which keys need to be used. The security association that applies to a given IPSEC header is determined by the packet destination IP address and the security parameter index SPI in the packet header. Whenever a host processor receives an IPSEC header it uses the SPI to identify the cryptokeys and procedures to use with it. The IPSEC software needs to maintain the following information for each SPI: a specification of the cryptographic methods to be used by that SPI; the keys to be used by the cryptographic methods when processing traffic for that SPI; and the hosts or other entities associated with this traffic.

When a host applies IPSEC protection to an outgoing packet, it uses a security association belonging to the destination. A host applies the cryptographic method and key of that association to the data to protect it, and inserts the SPI of the association in the IPSEC header. This process is then repeated in a second IPSEC header if it is applied in front of the other one.

When a host processes the first IPSEC header in an incoming packet, the SPI is used to identify the appropriate security association. Then the host applies the indicated cryptographic method to the header using the indicator key.

The specific subject matter of the present application is Internet Key Exchange (IKE). This is a hybrid protocol whose purpose is to negotiate and provide authenticated keying materials for securing associations in a protected manner. IKE enables remote users from a remote site to access a secure host or network and is used for negotiating VPNs.

An IKE is made up of a Main Mode (MM) and one or more Quick Modes (QM). IKE presents different exchanges as modes which operate in one of two phases. Phase 1 is where two Internet Security Association and Key Management Protocol (ISAKMP) peers establish a secure authenticated channel with which to communicate. This is called the ISAKMP security association (SA). “Main Mode” of IKE is such a phase 1 exchange. Phase 2 is where Security Associations are negotiated on behalf of services such as IPSEC or any other service which needs key material and/or parameter negotiation. IKE “Quick Mode” accomplishes a phase two exchange.

From the above, it can be seen that exchanges are composed of an initial Main Mode exchange followed by possibly several Quick Mode exchanges.

Software implementation of IKE is generally adopted but has the drawback that it is slow, principally because IKE Main Mode is relatively slow.

One solution for overcoming the problem is to provide a full hardware gateway between hosts, but this tends to be an expensive solution.

Apart from such hardware solutions, other methods have tried to improve on the software solutions but for each software solution, the machine needs to be booted first and software agents run as modules of the operating system.

If for any reason a machine needs reconfigurating, then the machine will need to be shut down and reinitialised which could perhaps take 15 to 20 minutes.

Embodiments of the present invention aim to accelerate IKE by allowing later phases of key-exchange to proceed earlier, thus reducing the overall time spent in a full blown IKE exchange.

Embodiments of the present invention implement IKE by implementing Main Mode in hardware rather than software. In which case, by the time the operating system of the machine has come up, Main Mode can have already been carried out so that Quick Mode is ready.

According to a first aspect of the present invention there is provided an Internet Key Exchange method, wherein an IKE Main Mode is implemented in hardware in parallel with system software loading.

Preferably, IKE Main Mode is implemented in hardware on a network adapator and begins following initialisation of the network adapator and initialisation of a TCP/IP stack embedded on the network adaptor.

Preferably, IKE Main Mode is carried out at network adapator level and in parallel with main system startup, wherein the main system comprises one or more server and a plurality of devices and main system start up comprises a time in which the or each server and the plurality of devices take to initialise, the operating system loads, applications load and software services initialise.

Preferably, following initialisation of software services, a system IKE daemon/program is begun which fetches the precomputed Main Mode results from the hardware implemented Main Mode prior to implementing one or more Quick Modes.

Preferably, said Main Mode is in compliance with RFC2409 and wherein an identification payload type thereof comprises a machine identity type derived from a hardware configuration of IKE peers.

Preferably, said machine identity type is available in hardware from each device which constitutes an IKE peer. Preferably, for each peer, said machine identity is a fixed value which, so long as the hardware configuration of the machine remains constant, is unchanged and fixed in hardware.

Preferably, said machine identity comprises a CPU serial number.

Preferably, when the IKE peer is a network adaptor, said machine identity comprises a hardware MAC address.

Preferably, said machine identity comprises a chassis or mother board serial number.

In preferred embodiments of the present invention, the devices are enabled so as to perform IKE Main Mode exchanges by the introduction of a new machine—ID type independent of the actual IKE—agent which is typically software driven.

By implementing the above, Main Mode exchanges may occur even before a system has booted on its operating system or begun running any programs/daemons that perform IKE exchanges. Main Mode exchanges may also occur on systems without conventional operating systems, although in such cases the computed Main Mode SAs may be used instead by other system entities (hardware systems).

In such preferred embodiments, Main Mode exchanges may have finished by the time a Quick Mode negotiation has to take place—as Quick Mode (QM) typically occurs on behalf of remote clients wishing to establish an IPSEC tunnel.

As a result of the introduction of a new machine-ID type as a valid type in IKE exchanges, the entire Main Mode exchange can be carried out by hardware external to an actual IKE exchange which is then simply reduced to picking out the results of the prior machine to machine exchange and performing one or more Quick Mode exchanges thereafter.

Another advantage concerns rebooting of machines. Unless a machine's configuration has changed, then the result of a machine to machine authentication should remain valid across reboots and, therefore, IKE Main Mode could be possibly avoided across a reboot.

For a better understanding of the invention, and to show how embodiments of the same may be carried into effect, reference will now be made, by way of example, to the accompanying diagrammatic drawings in which:

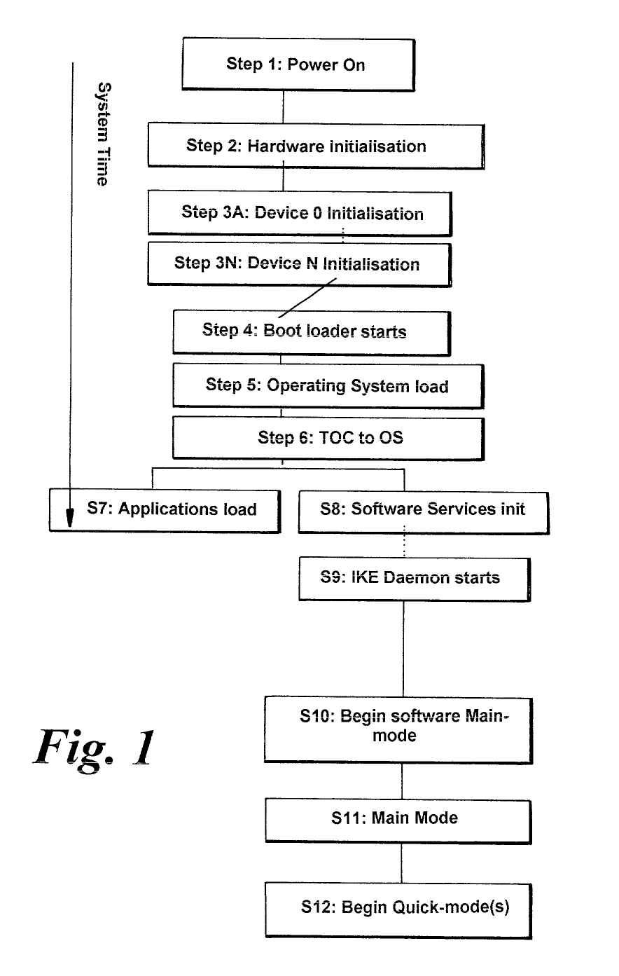

FIG. 1 illustrates the normal follow of events which occurs in a prior art entirely software implemented system;

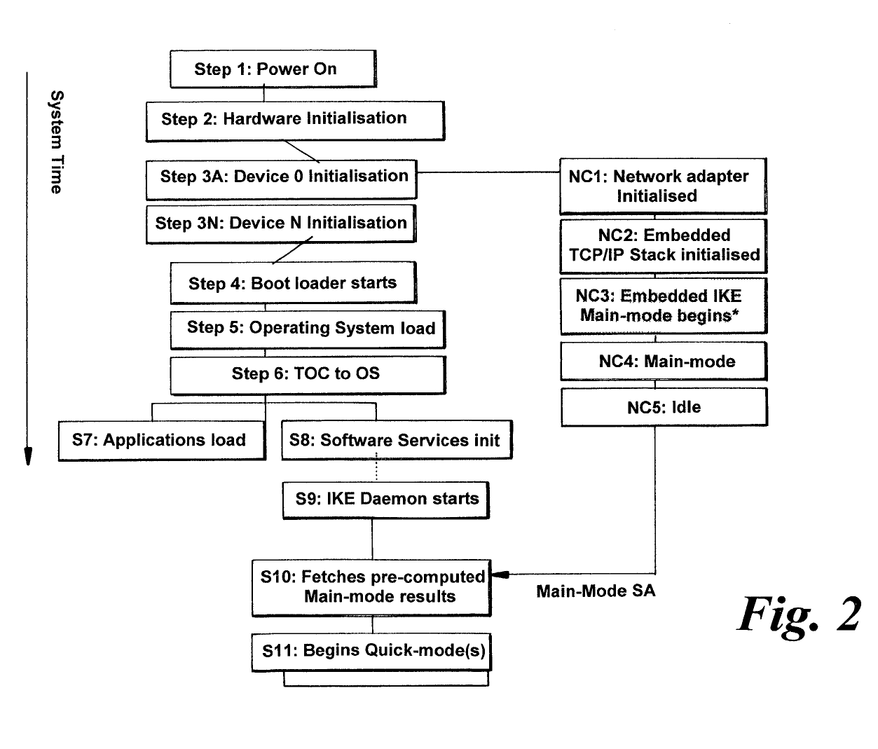

FIG. 2 illustrates in schematic version in system time how an accelerated IKE in accordance with a preferred embodiment of the invention may be implemented;

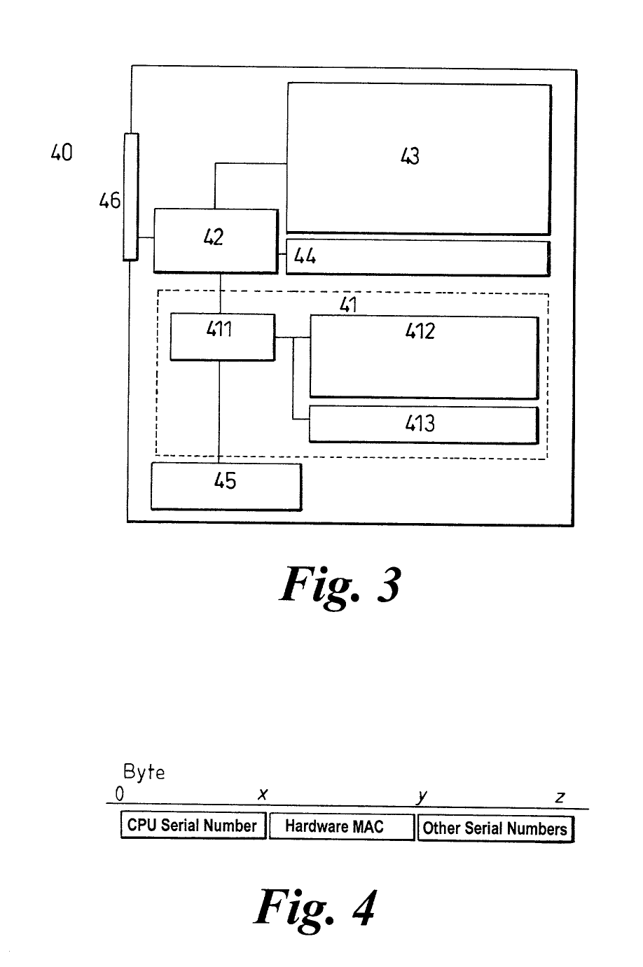

FIG. 3 illustrates an embodiment of a network card including hardware implementation of IKE Main Mode; and

FIG. 4 shows the binary-encoding of a Machine-ID type payload.

Considering now FIG. 1, it will be described how a conventional software implemented Internet Key Exchange (IKE) is carried out and the associated system timings.

In step 1 system power on occurs. There is then carried out the step of hardware initialisation in step 2 with device 0 to device N initialisation in steps 3A to 3N. In step 4, the boot loader starts, followed by operating system load in step 5 and then transfer of control to the operating system occurs (TOC to OS) in step 6. After step 6, the applications load and the software services initialise in steps 7 and 8.

It is only after the software services have initialised, that the IKE daemon starts in step 9, whereafter a main mode is begun in step 10, carried out in step 11 and then, finally, the quick modes can begin in step 12.

Considering the operations carried out in FIG. 1, it can be seen that they are carried out in a generally serial fashion. In this regard, because Main Mode cannot start until the software services have initialised and because Main Mode itself actually takes up a lot of system time, meaningful Quick Mode exchanges are substantially delayed.

Referring now to FIG. 2, implementation of accelerated IKE according to embodiments of the invention will be discussed.

Referring to FIG. 2 in particular, there is shown in overall system time the sequence of events.

In step 1, system power-on occurs followed by hardware initialisation in step 2 and device initialisation in steps 3A to 3N. Device initialisation provides the cue for carrying out initialisation on the network card upon which the hardware implementation of Main-Mode is embodied.

Following device initialisation in step 3, the boot loader starts in step 4, followed by operating system load, step 5, and then TOC to OS in step 6.

Following step 6, applications load in step 7 and, in parallel, software systems are initialised in step 8. In the course of these software services, the IKE daemon starts, step 8A, with precomputed Main Mode results being fetched from the network card in step 8B. As Main Mode has effectively now been completed, one or more Quick Modes may be begun in step 8C.

The procedures now carried out by the network card, triggered by the device initialisations in step 3 will be discussed.

In step NC1, the network adaptor is initialised, followed by the embedded TCP/IP stack being initialised in step NC2. Embedded IKE Main Mode then begins in step NC3 and is completed in step NC4, whereafter there may be an idle period NC5 before the results from that Main Mode are fetched by the IKE daemon in step 8B before commencing the Quick Modes in step 8C.

From the discussion of FIG. 2, it will be appreciated that by implementing the Main Mode in hardware and by initialising Main Mode at a much earlier system time in parallel with the main operating system mode, Main Mode results are available for use, at a much earlier system time, i.e. as soon as the software services have initialised, the IKE daemon can fetch the results of the Main Mode. So, at a point at which Main Mode would normally be just beginning, the IKE daemon can fetch precomputed Main Mode results so as to launch straight into Quick Modes thereafter.

It is important to realise that the embedded IKE Main Mode referred to is the IKE Main Mode as described in IKE RFC2409 in format, ordering and encoding—except for one important detail: when identities of IKE peers are passed (Idii-initiator ID-and IDir-responder ID) the identity payload includes a reference to a newly defined identity-payload type (for a list of currently allowably Identity-payload types, see the aforementioned RFC2408 on the ISAKMP Protocol Appendix A.4 ISAKMP Identification Type Values). Currently defined types under the aforementioned protocol are:

| ID Type | Value |
|---|---|
| ID_IPV4_ADDR | 0 |
| ID_IPV4_ADDR_SUBNET | 1 |
| ID_IPV6_ADDR | 2 |
| ID_IPV6_ADDR_SUBNET | 3 |

The newly defined identify payload type is a unique machine ID derived from a function of hardware encoded values in the various hardware components of the host system. Examples of such a machine ID are: a CPU serial number representing each CPU present; a hardware MAC address for each network adapator present; and serial numbers of the chassis or mother board for other machines. With this implementation, a new machine-ID type may be defined as below:

| ID Type | Value |
|---|---|
| ID_IPV4_ADDR | 0 |
| ID_IPV4_ADDR_SUBNET | 2 |
| ID_IPV6_ADDR | 2 |
| ID_IPV6_ADDR_SUBNET | 3 |
| ID_MACHINE_ID | 4 |

The key advantage to providing this new ID-type is that it is fixed according to the individual machine hardware and is made available in hardware form, e.g. a fixed value stored in a register. Therefore, because this value is always available, the Main Mode being implemented by, for instance, hardware on a network card can always interrogate the machine ID value of a device and does not need to wait for software loading on that device.

The binary-encoding of the machine-ID payload may be as shown in FIG. 4.

The format of the identification payload used in Main Mode may be the same as that defined in section 3.8 of the ISAKMP RFC2408:

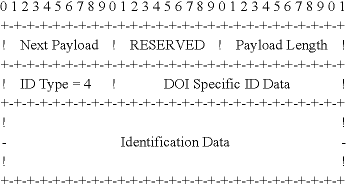

As shown above, the only difference in the Main Mode carried out by the present invention is that in the particular hardware implementation, the “ID type” field is set to 4. Therefore, the Main Mode negotiation proceeds according to one of the four submodes defined in the defined ID_machine_ID type.

The illustrations below show the exchanges in which the use of the modified identity payload is highlighted in bold. Otherwise, the other payloads remain the same as for normal IKE Main Mode.

Also note that both IKE peers negotiating will have to use the same ID-type (4) for machine to machine authentication.

Authenticated with Signatures

| Initiation | | Responder |
|---|---|---|
| HDR, SA | → | |
| | ← | HDR, SA |
| HDR, KE, Ni | → | |
| | ← | HDR, KE, Nr |
| HDR*, IDii, [CERT,] SIG_I | → | |
| | ← | HDR, IDir, [CERT,] SIG_R |

Authenticated with Public Key Encryption

| Initiation | | Responder |
|---|---|---|
| HDR, SA | → | |
| | ← | HDR, SA |
| HDR, KE< [HASH(1),] | | |
| <IDii_b>PubKey_r, | | |
| <Ni_b>Pubkey_r | → | |
| | | HDR, KB, <IDir_b>PubKey_i, |
| | ← | <Nr_b<PubKey_I |
| HDR*, HASH_I | → | HDR, HASH_R |

Authenticated with Revised Mode Public Key Encryption

| Initiation | | Responder |
|---|---|---|
| HDR, SA | → | |
| | ← | HDR, SA |
| HDR, [HASH(1),] | | |
| <Ni_b>Pubkey_r, | | |
| <KE_b>Ke_i, | | |
| <IDii_b>Ke_i, | | |
| [<Ke_i] | → | |
| | | HDR, <Nr_b>PubKey_i, |
| | | <KE_b>Ke_r, |
| | ← | <IDir_b>Ke_r, |
| HDR*, HASH_I | → | |
| | ← | HDR*, HASH_R |

Authenticated with Pre-shared Key

| Initiation | | Responder |
|---|---|---|
| HDR, SA | → | |
| | ← | HDR, SA |
| HDR, KE, Ni | → | |
| | ← | HDR, KE, Nr |
| HDR, IDii, HASH_I | → | |
| | ← | HDR*, IDir, HASH_R |

Referring now to FIG. 3, there is shown an example of a network card 40 including the hardware for IKE Main Mode implementation.

The hardware components comprise an integrated circuit 41 for implementing the TCP/IP stack, a microprocessor 42 for directing operations, an EEPROM 43 which contains controller codes for external (PCI) interfacing, I/O routines to maintain transfer of data between IC and external interfaces and IKE configuration data (for example, certificates, private keys and security policy database SPD), a RAM 44 for holding buffered network data for transmission to the host PC, a physical LAN interface 45 (such as RJ45) and an external interface (PCI) 46.

The IC implementing TCP/IP stack 41 contains one or more ASIC controllers 411, a ROM/EEPROM 412 containing the code for the IKE Main Mode, the TCP/IP stack and device driver for LAN interface and a RAM 413 containing run time data such as routing tables etc.

The abovementioned hardware components are packaged together onto a card with external interface so as to be used on conventional operating systems with a software device-driver to communicate with the card. The software device-driver would make available the Main-Mode negotiation results (in the form of Main-Mode Security Assocations—SAs) to the host operating system and, specifically in step S10 of FIG. 2 to the IKE-daemon running above the host operating system.

It can be envisaged that the development of technology may enable such devices as handheld computers, PDAs, etc. to become fully functioning peers within a VPN.

It is therefore to be noted that the results of pre-computed Main Modes are also of utility in relation to such “instant-on” devices.

The invention is not restricted to the details of the foregoing embodiment(s).

1. An Internet Key Exchange method, wherein an IKE Main Mode is implemented in hardware in parallel with system software loading.

2. A method according to claim 1, wherein IKE Main Mode is implemented in hardware on a network adapator and begins following initialisation of the network adapator and initialisation of a TCP/IP stack embedded on the network adaptor.

3. A method according to claim 1 or 2, wherein IKE Main Mode is carried out at network adapator level and in parallel with main system startup, wherein the main system comprises one or more server and a plurality of devices and main system start up comprises a time in which the or each server and the plurality of devices take to initialise, the operating system loads, applications load and software services initialise.

4. A method according to the preceding claims, wherein following initialisation of software services, a system IKE daemon/program is begun which fetches the precomputed Main Mode results from the hardware implemented Main Mode prior to implementing one or more Quick Modes.

5. A method according to any of the preceding claims, wherein said Main Mode is in compliance with RFC2409 and wherein an identification payload type thereof comprises a machine identity type derived from a hardware configuration of IKE peers.

6. A method according to claim 5, wherein said machine identity type is available in hardware from each device which constitutes an IKE peer.

7. A method according to claim 5 or 6, wherein for each peer, said machine identity is a fixed value which, so long as the hardware configuration of the machine remains constant, is unchanged and fixed in hardware.

8. A method according to claim 5 or 6, wherein said machine identity comprises a CPU serial number.

9. A method according to claim 5 or 6, wherein when the IKE peer is a network adaptor, said machine identity comprises a hardware MAC address.

10. A method according to claim 5 or 6, wherein said machine identity comprises a chassis or mother board serial number.

11. A method substantially as herein described with reference to FIG. 2 onwards.
